(19) United States
(12) Patent Application Publication
(10) Pub. No.: US 2010/0218298 A1
(43) Pub. Date: Sep. 2, 2010

(54) Apparel

(75) Inventors: Martina Stattelmann, Herzogenaurach (DE); Nina Maria Ludwig, Nuernberg (DE); Pauline Nolan, Huelva (ES); Andrea Simon, Freiburg (DE)

Correspondence Address: STERNE, KESSLER, GOLDSTEIN & FOX, P.L.L.C., 1100 NEW YORK AVENUE, N.W., WASHINGTON, DC, 20005, US

(73) Assignee: adidas International Marketing B.V., Amsterdam ZO (NL)

(21) Appl. No.: 12/543,880

(22) Filed: Aug. 19, 2009

(30) Foreign Application Priority Data
Aug. 19, 2008 (DE) 102008038360.0-26

(51) Int. Cl. A41D 1/00; B28B 1/14

(52) U.S. Cl. 2/69; 264/299

(57) ABSTRACT

A garment which minimizes chafing includes a three-dimensional heat molded area and a seam connecting a front area of the garment with a back area of the garment. The seam may be curved and shaped to create a three-dimensionally shaped area.

### BACKGROUND OF THE INVENTION

1. Field of the Invention

The present invention relates to apparel which may provide high freedom of movement and/or wearer comfort. The present invention relates in particular to a garment with three-dimensionally formed areas.

2. Background Art

Apparel, in particular sportswear, frequently uses lightweight and elastic materials such as elastan which fit tighter to the body than conventional textile materials. Conventional garments impede movements due to their wide shape and require more effort for moving a part of the body due to the higher weight.

On the other hand, a tight-fitting garment is constantly stretched and compressed during movement of the wearer, and therefore, can create wrinkles during wear. The creation of wrinkles reduces the freedom of movement of the wearer and can lead to wearout of the garment. Such disadvantages are particularly relevant for sportswear because the wearer, for example a runner, makes fast and frequent movements.

It is known to three-dimensionally form garments. For example, U.S. Pat. No. 4,645,629 describes the manufacture of a shirt by heat molding using a mold, in order to simplify the manufacturing process. During the process, two fabric sheets are pressed, by two negative molds, to a positive mold of an upper part of the body and are subsequently connected. However, seams remain at the connection of the two fabric sheets.

Three-dimensional shaping of a textile material by molding is furthermore known from U.S. Pat. No. 6,659,501 where it is applied to make shoulder sections for garments which are to be rainproof. Similar methods are described in the U.S. Pat. No. 5,855,124, U.S. Pat. No. 3,597,800 and U.S. Pat. No. 4,202,853.

Furthermore, U.S. Pat. No. 5,031,242 describes bellows at the elbow and at the knee. The U.S. Pat. No. 5,159,721, U.S. Pat. No. 5,608,913 and U.S. Pat. No. 6,817,029 disclose various insets for garments, in order to improve the freedom of movements.

Shaping of a garment by a curved seam is described in WO 01/26494, in order to provide a better three-dimensional fit. Shaping of a garment by seams is furthermore described in U.S. Pat. No. 3,959,826, EP 0 519 135 B1, U.S. Pat. No. 3,744,052, DE 870 11 48 U1, FR 2 754 680 A1, U.S. Pat. No. 3,654,632, U.S. Pat. No. 5,724,674 and FR 2 361 269.

In spite of the three-dimensionally formed areas used in these garments, there remain seams in each of the cases which significantly reduce wearer comfort as a result of skin chafing. Seams reduce the wearer comfort since they are usually stiffer than the textile material of the garment and even may comprise sharp edges which chafe the skin during movements. This is particularly disadvantageous for tight-fitting sportswear which has to provide comfort during movement.

Therefore, a need exists to provide a garment which may combine freedom of movement and wearer comfort and which in particular may help avoid unpleasant chafing of seams on the skin as much as possible.

### BRIEF SUMMARY OF THE INVENTION

The present invention meets the above-described need in one embodiment with a three-dimensional garment which may minimize chafing that includes a three-dimensional molded area and a curved seam connecting a front area of the garment with a back area of the garment to create the three-dimensional garment including the three-dimensional molded area

The three-dimensional molded area may be formed by heat in order to increase freedom of movement and wearer comfort because stretching and compressing of the garment during movement may be reduced. However, a good fit exclusively by three-dimensional molded areas is difficult to manufacture, at least for a tight fitting garment. Namely, seams are necessary for the manufacture of the garment, even if they reduce the wearer comfort.

The present invention combines a three-dimensional molded area formed by heat and a curved seam which connects the front area and the back area of the garment to create the inventive three-dimensional garment. This structure leads to a garment which may provide both increased freedom of movement by reduced stretching and compressing of garment and improved wearer comfort by reduced skin chafing. Since the seam is curved, it is not exclusively located in areas of the body (such as between the legs) which are particularly sensitive to skin irritation by chafing seams.

In contrast to this, seams according to the prior art which are usually needed for connecting the front and the back of the garment typically run essentially straight on the lateral sides on the upper part of the body and between the legs. However, seams in these areas are most disturbing for athletes. For example, arms and legs are continuously moving during running so that the arms permanently chafe laterally on the upper body, respectively the legs chafe against each other. If in addition seams are located laterally at the upper body or between the legs, friction is further increased and may cause skin chafing. In the garment according to the invention, the seam may be curved and therefore leads away from the lateral area at the upper body or the area between the legs.

In addition, a first three-dimensional molded area formed by heat according to the invention may have further advantages. First, freedom of movement may be improved by reducing stretching and compressing of the garment during movements. This may hold true in particular in the area of joints such as the shoulder, the elbow or the knee where garments are particularly deformed by movements of the joints. On the other hand, wearer comfort may be improved in those areas in which the surface of the human body is strongly curved since deformations of the garment may be reduced in these areas.

Further, the use of the first three dimensional molded area may reduce the number of seams, which otherwise would be required for creating a three-dimensional shape. The same advantages may apply for the three-dimensional garment shaped by the curved seam according to the invention. Such a three dimensional garment may be created, for example, by connecting (flat) patterns having non-parallel edges.

In some embodiments, the seam may intersect a medial frontal plane of the body of the wearer of the garment. The medial frontal plane is the medial plane which is visible in a frontal view of a human body and which vertically intersects the body. This may be advantageous since the medial frontal plane of the body comprises several particularly sensitive areas of the body and since the curved seam may only intersect these areas, and therefore is not fully located within these areas. Apart from creating the three-dimensional garment, the seam according to the invention may thereby fulfill a second independent function by avoiding sensitive areas of the body.

In some embodiments, the seam may intersect the medial frontal plane of the body of the wearer of the garment more than once. This may be required for particular patterns. However, also in this case the seam does not run in the medial frontal plane so that skin chafing may be avoided.

In some embodiments, the seam may comprise two oppositely curved sections. This particular form of the seam may enable, together with the feature of three-dimensional garment being created by the seam, an adjustment of the garment to three-dimensional anatomical forms with changing curvatures. Such shaping by the seam may be advantageous for larger regions compared to the use of areas formed by heat and can be accurately manufactured.

In a further embodiment, the seam may comprise an upper curved section which may extend at least partially in front of the medial frontal plane and a lower curved section which may extend at least partially behind the medial frontal plane. This run of the seam may enable a good adjustment of the shape of the garment to curved anatomical surfaces of the body.

In some embodiments, the front area and the back area of the garment may be manufactured from a single textile part. In this way, the number of seams of the garment can be significantly reduced which may increase the wearer comfort.

In a further embodiment, the seam may be bonded by welding and/or gluing. The seam may be located on the side of the garment away from the skin. Skin irritations are not only caused by the location of the seams but also by the particular form of the seams themselves. The manufacture of a seam by welding and/or gluing may enable a very flat and even seam and therefore may minimize skin irritation. By further arranging the seam on the side of the garment away from the skin, all edges of the textile material are located on the outside and therefore cannot cause skin irritation.

In a further embodiment, a sleeve edge of the garment may be formed such that it comprises a recess for the bones of the wrist. Further, a trouser leg edge of the garment may be formed such that it comprises a recess for the ankle. This supports a tight-fitting garment which may avoid pressure and chafing on these particularly sensitive bones caused by the sleeve edge and the trouser leg edge, respectively.

In some embodiments, the garment may comprise flexible inserts. Since different areas of the garment are differently stretched, the freedom of movements can be improved by providing particular areas with flexible insets, in particular when these areas are subject to strong deformations.

In further embodiments, the garment may comprise bellows. Since, for example, joints with a large range of movement such as the elbow or the knee cause corresponding deformations of the garment, it can be advantageous to arrange bellows in these areas.

In further embodiments, the at least one first three-dimensional molded area of the garment formed by heat may be arranged in the area of the neck, the shoulder, the elbow, the breast and/or the knee. In these areas the human body has a particularly strong curvature so that a correspondingly formed three-dimensional area may reduce skin chafing and/or increases freedom of movement.

In some embodiments, the garment may essentially consist of polyester, and may be made from 100% polyester. The three-dimensional molded area formed by heat may be manufactured by molding with a temperature in a range between 150° C.-200° C., and in some embodiments may be in a range between 185° C.-195° C. This combination of material and temperature may result in a particularly effective shaping of the three-dimensional area formed by heat.

In an alternative embodiment, the garment may essentially consist of a nylon-elastan textile material, and may be made from 100% nylon-elastan, and the three-dimensional area formed by heat may be molded at a temperature in a range between 150° C.-200° C., and in some embodiments the temperature may be 195° C.

Forming of the garment may last for a time period of 10-25 seconds. After this time period a durable shaping of the first three-dimensional area is obtained, without damaging the material of the garment.

In some embodiments, the mold for forming may have an immersion depth of 1.5 to 2.5 times the resulting depth of the garment. In some embodiments, the immersion depth of the mold may be in the range of 45 mm to 90 mm and the resulting depth of the garment may be in the range of 15 mm to 60 mm.

### BRIEF DESCRIPTION OF THE DRAWINGS/FIGURES

The present invention is explained with reference to the accompanying drawings.

FIG. 1 shows schematic views of particularly stressed zones of garments during movement.

FIG. 2 is a schematic front view and back view of an exemplary article of sportswear according to one embodiment.

FIG. 3 is a schematic representation of anatomical planes of a human body.

FIG. 4 is an exemplary pattern of a front area and a sleeve of the exemplary article of sportswear shown in FIG. 2.

FIG. 5 is an exemplary pattern of a back area and a sleeve of the exemplary article of sportswear shown in FIG. 2.

FIG. 6 is an exemplary pattern of an article of sportswear which consists of a single part according to one embodiment.

FIG. 7 is an exemplary pattern of an article of sportswear with a front area and a back area according to one embodiment.

FIG. 8 is a further embodiment of an exemplary article of sportswear.

FIG. 9 is a further embodiment of an exemplary article of sportswear.

FIG. 10 is a schematic front view and back view of an exemplary article of sportswear according to one embodiment.

FIG. 11 is an exemplary derivation of the pattern of the exemplary article of sportswear from FIG. 10.

FIG. 12 is an exemplary derivation of a pattern of the exemplary article of sportswear from FIG. 10.

FIG. 13 is an exemplary pattern and a corresponding exemplary article of sportswear according to one embodiment.

FIG. 14 is a schematic front view and back view of an exemplary article of sportswear according to one embodiment.

FIG. 15 is embodiments of an article of sportswear in the area of the sleeve edge and the leg trouser edge;

FIG. 16 shows embodiments of an exemplary article of sportswear in the area of the collar.

FIG. 17 shows further embodiments of an exemplary article of sportswear in the area of the collar.

FIG. 18 is a view of an embodiment of a stretchable area of an exemplary article of sportswear according to one embodiment.

FIG. 19 is a view of an exemplary apparatus for molding of textile materials.

FIG. 20 show the steps of an exemplary method for seam bonding.

### DETAILED DESCRIPTION OF THE INVENTION

Embodiments of the present invention of an article of sportswear are described below in detail. However, it is to be understood that the present invention is not limited to articles of sportswear, but can be applied to other garments in order to improve the freedom of movement and wearer comfort.

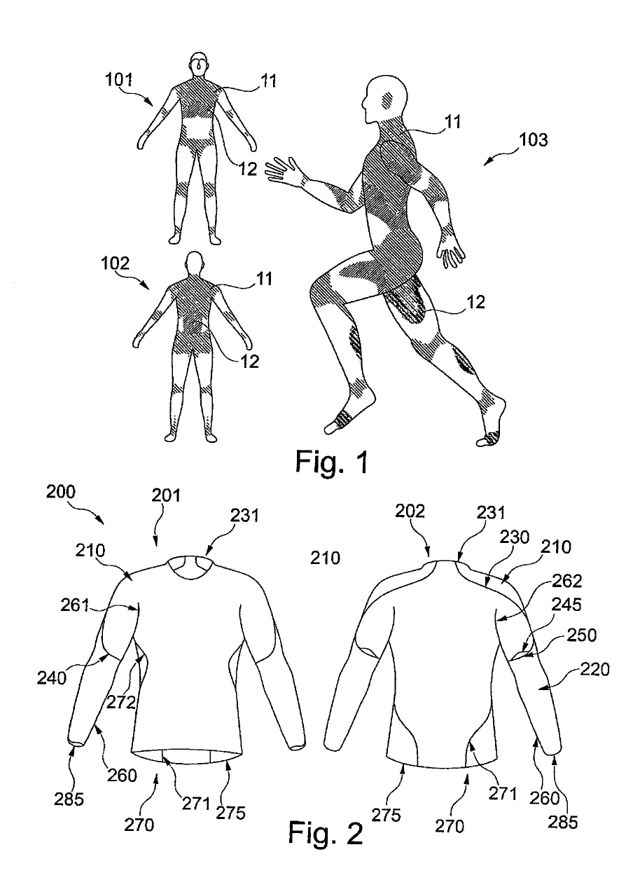

FIG. 1 shows a schematic front view 101, back view 102 and side view 103 of a human body in which primary stressed zones 11 and secondary stressed zones 12 are illustrated. These zones may be particularly relevant during sports. The zones 11, 12 essentially extend from the neck and the shoulders along the upper part of the body, from the hip downwards, between the thighs, and in the area of the elbow, the bones of the wrist, the knee and the ankle.

In zones 11, 12 the material of the article of sportswear, for example a textile fabric, may be stressed by movements in several respects. On the one hand, the material may be stressed and compressed during each movement of the joints, especially the shoulder, the knee and the elbow. Therefore, abrasion of the article of sportswear with the wearer's skin can be observed in these areas. On the other hand, the material in the zones 11, 12 may be stressed in that parts of the article of sportswear continuously rub against each other, in particular between the arms and the upper part of the body and between the legs. This may lead to abrasion of the material which is particularly problematic along the seams.

The stress on the article of sportswear in the zones 11, 12 may have additional disadvantages for the person who wears the article of sportswear. Stretching and compressing of the material in the area of the joints may limit freedom of movement and may require additional force to be exerted by the wearer. In addition, this may cause rubbing of the material on the skin which may cause chafing which is even worse when seams are located in these areas. As a result of the connection of two parts of a textile material, seams may be stiffer than the textile material itself and may in addition comprise sharp edges of the textile material. Also the sewing thread itself, in particular when made from a stronger material, may lead to skin chafing. Seams can also be glued or welded so that the use of sewing threads can be avoided for connecting two textile parts. The manufacture of seams is described below in connection with FIG. 20. Skin chafing may in addition occur when parts of the article of sportswear rub against each other, in particular between the arms and the upper part of the body and between the legs.

The mentioned problems may be particularly relevant for tight-fitting garments which provide more freedom of movements due to their lower weight and their form fit than wide-shaped garments so that tight-fitting garments are preferred for sports activities.

FIG. 2 shows schematically a front view 201 and a back view 202 of an article of sportswear 200 according to an embodiment of the present invention which may solve one or more of the above mentioned problems. The article of sportswear 200 may provide an integral solution which not only provides freedom of movement by three-dimensional molded areas formed by heat, but also may enable a high wearer comfort by altering the shape of the seams, thereby minimizing skin chafing caused by the seams. In addition, seam abrasion may be reduced.

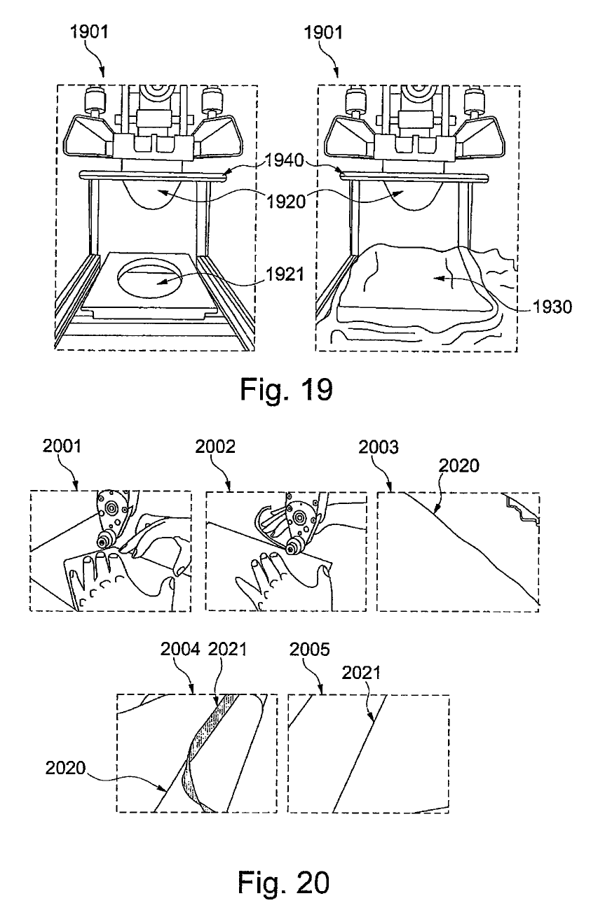

As can be recognized in FIG. 2, the schematically illustrated article of sportswear 200 has no seams on the shoulder and on the back side of the elbow. Rather, three-dimensional areas formed by heat are arranged in the areas 210, 220 whose manufacture is described below in connection with FIG. 19. The areas formed by heat 210, 220 may offer freedom of movement for the shoulder and the elbow and reduce stretching and compressing of the article of sportswear during movements.

In order to minimize their disadvantages, the seams of the article of sportswear illustrated in FIG. 2 may be shifted with respect to the conventional straight lateral seams and therefore may avoid areas which are critical for skin chafing. As can be recognized in FIG. 2, a curved seam 270 runs from the lower edge 275 on the back side 202 of the article of sportswear to the armpit area where it meets the sleeve seam 260 of the sleeve.

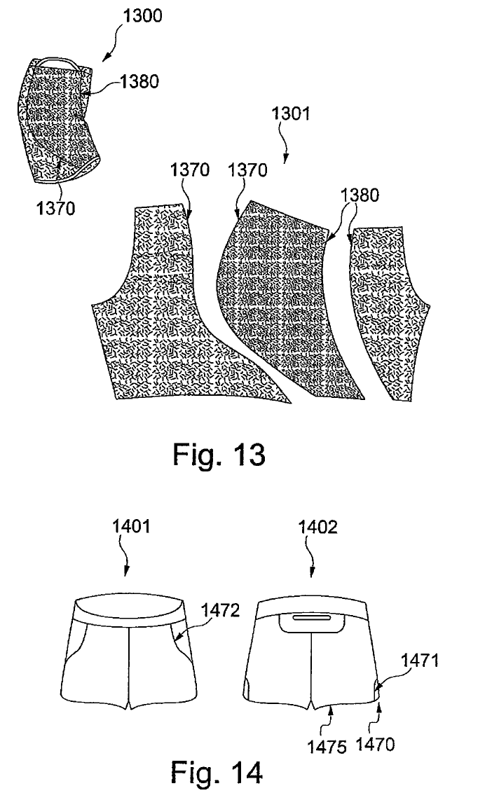

In one embodiment, the seam 270 may comprise essentially two sections, wherein the lower section 271 may extend at least partially on the back side 202 and wherein the upper section 272 may extend at least partially on the front side 201 of the article of sportswear. In a further embodiment, the lower section 271 may extend on the front side 201 and the upper section 272 may extend on the back side 202. In some embodiments the lower section 271 and the upper section 272 may be oppositely curved. In addition to circumventing sensitive zones, curved seams may enable a three-dimensional shaping of the area of the curved seams which is described below in connection with FIGS. 12 and 13. In a further embodiment, seam 270 may comprise one or more straight sections.

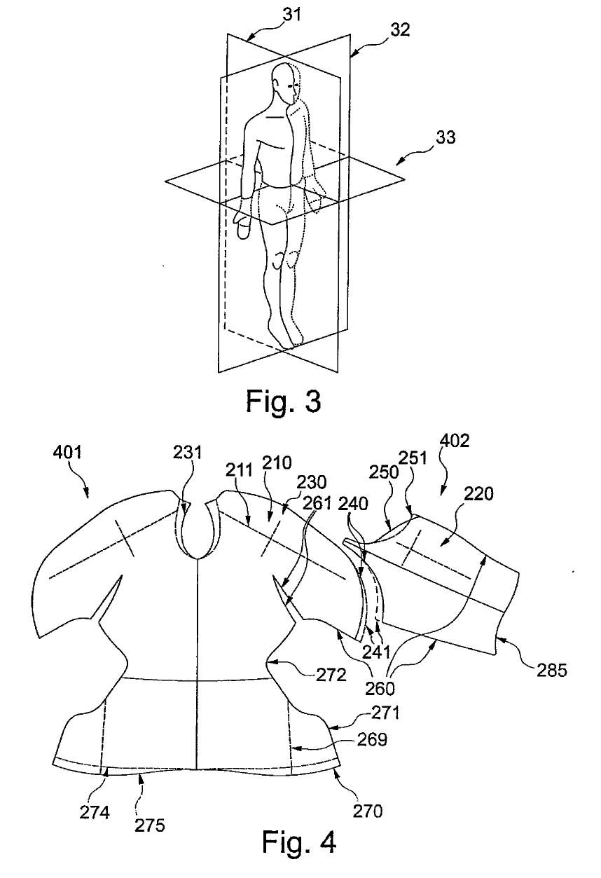

A further feature of the seam 270 is illustrated in connection with FIG. 3. FIG. 3 is a schematic representation of anatomical planes of a human body wherein the frontal plane 32, the sagittal plane 31 and the transversal plane 33 can be recognized. The frontal plane 32 is the plane which is visible in a frontal view of a human body and which runs vertically through the body. The medial frontal plane is the frontal plane which runs through the centre of the body. For simplicity, the medial frontal plane is designated as frontal plane 32 in the figures and the following description. Typically, the front side and the back side of a garment are connected along the frontal plane 32. This holds true, for example, for U.S. Pat. No. 4,645,629 which is discussed in the introduction of the present application.

Therefore, the run of the seam 270 can be described as having an intersection with the frontal plane 32 of a body for which the article of sportswear is determined. Such a seam is appropriate for connecting a front area and a back area of an article of sportswear, since this seam runs in the area of the frontal plane 32. As a result of its curvature, the seam 270 leads away from the frontal plane 32 which may reduce skin chafing. In the embodiment of FIG. 2, seam 270 and the frontal plane 32 may intersect twice, namely at the transition from the back side 202 to the front side 201 and in the armpit area where seam 270 meets the sleeve seam 260. Seam 270 therefore is a shifted form of the conventional straight seam along the frontal plane 32.

Referring again to FIG. 2, a curved shoulder seam 230 on the back side 202 of the article of sportswear 200 can further be recognized. Shoulder seam 230 may extend from collar 231 and below the shoulder area 210 formed by heat and may split on the upper sleeve into a front seam 240 (which runs on the front side 201) and a back seam 250. Both seams 240, 250 may further run around the upper sleeve and meet at the sleeve seam 260. The back seam 250 may extend above the elbow area 220 formed by heat. In an alternative embodiment (not illustrated), shoulder seam 230 may extend on the front side 201 of the article of sportswear.

Similar to seam 270, shoulder seam 230 and frontal plane 32 of the body for which the article of sportswear 200 is determined, intersect in FIG. 2. In some embodiments, the intersection with frontal plane 32 may be located in the area of the intersection of shoulder seam 230, front seam 240 and back seam 250. Therefore, similar to seam 270, shoulder seam 230 is appropriate for connecting a front area and a back area of the article of sportswear 200. Since shoulder seam 230 is in addition curved, it does not further extend along frontal plane 32 but leaves this area and therefore may enable arranging a three-dimensional area 210 formed by heat on the shoulder which provides freedom of movements without impeding wearer comfort by the seams.

Further, FIG. 2 shows sleeve seam 260 mentioned above which runs on the sleeve of the article of sportswear. Sleeve seam 260 may extend from sleeve edge 285 and meets the upper section 272 of seam 270, at which point sleeve seam 260 may split into seam 261 on front side 201 and seam 262 on back side 202 of the article of sportswear. As can be recognized, seams 261, 262 may terminate below the area 210 formed by heat of the shoulder without meeting another seam. In an alternative embodiment (not illustrated), seam 262 may terminate at shoulder seam 230 on back side 202 of the article of sportswear. Preferably, sleeve seam 260 may run on the inner side of the sleeve. In an alternative embodiment (not illustrated), the sleeve seam 260 may run on the outer side of the sleeve.

In some embodiments, the seams may be symmetric between a right and a left side of the article of sportswear 200 in FIG. 2. Therefore, FIG. 2 as well as other figures illustrates the seams only on one side. In an alternative embodiment (not illustrated), the seams may run in an asymmetric manner. Asymmetric seams may be advantageous for particular sports such as fencing or tennis due to their asymmetric movements.

It can be further recognized in FIG. 2 that a stretchable insert 245 is arranged above back seam 250 on back side 202 of the article of sportswear. Stretchable insert 245 comprises an elastic material, preferably elastan. In one embodiment, stretchable insert 245 may abut back seam 250. As a result of the large angle of the flexion of the elbow of up to 180°, stretchable insert 245 may improve the freedom of movement in addition to area 220 formed by heat at the elbow. In further embodiments (not illustrated), stretchable inserts can be arranged in further positions of the article of sportswear which are subject to deformations during movements, for example in the area of the joints.

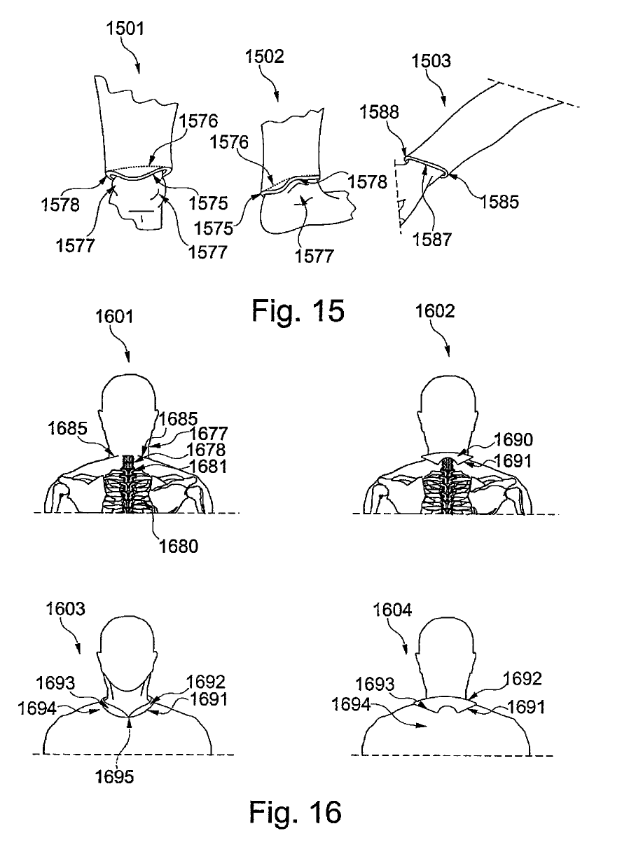

FIG. 2 further shows the anatomically formed sleeve edge 285 of the article of sportswear 200 which may improve wearer comfort, in particular of tight-fitting sportswear, which is explained in detail in connection with FIG. 15.

Preferably the seams in FIG. 2 may be manufactured by welding and are located on the side of the skin away from the article of sportswear 200 which results in smooth seams on the inside which may be advantageous for reduced skin chafing. The manufacture of such seams is described below in connection with FIG. 20.

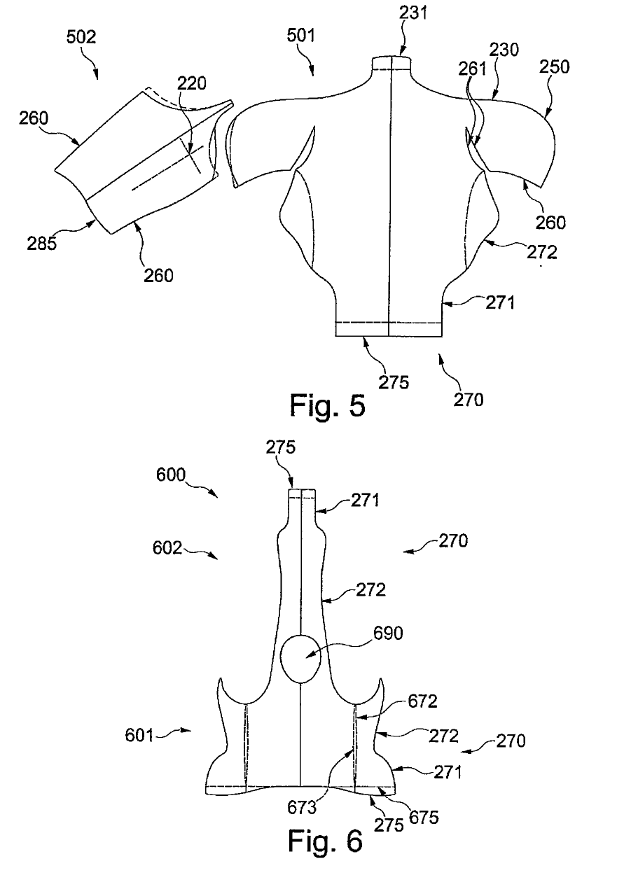

FIG. 4 shows a pattern of a front area 401 and a sleeve 402 which can be connected to the back area 501 and the sleeve 502 from FIG. 5, resulting in the article of sportswear 200 from FIG. 2. In each pattern, two edges form a seam. The two edges are connected during manufacture and are designated by the same reference numeral in the figures. The corresponding edge of an edge of the front area 401 in FIG. 4 can be located in FIG. 4 as well as in back area 501 in FIG. 5.

FIG. 4 illustrates seam 270 with lower section 271 and upper section 272 which may be curved and in some embodiments may be oppositely curved. Further, shoulder seam 230 and front seam 240 are illustrated. Back seam 250 extends on sleeve 402 and may be oppositely curved to shoulder seam 230 and front seam 240. Finally, sleeve seam 260 and seam 261 are illustrated. Further elements in FIG. 2 are the three-dimensional areas formed by heat on shoulder 210 and at elbow 220, collar 231, lower edge 275 and sleeve edge 285. Lower edge 275 and sleeve edge 285 may comprise plural curved sections which can also be recognized in FIG. 4. This shape omits the bones of the wrist so that sleeve edge 285 may be advantageously shaped because it may avoid pressure and/or chafing on the bones of the wrist and may improve wearer comfort. The anatomical shape of sleeve edge 285 is explained in more detail in connection with FIG. 15 below.

In FIG. 4, seam crosses 211 respectively indicate positions for placing a mold for creating a three-dimensional area formed by heat. This will be explained below in connection with FIG. 19. Results are three-dimensional areas at the shoulder and at the elbow.

Shifting of a conventional seam running in a sensitive zone to a less sensitive zone may furthermore be recognized in FIG. 4 in case of seam 270 (shifted from conventional seam 269) and lower edge 275 (shifted from conventional seam 274). Further, conventional seams 241, 251 may be shifted towards seams 240, 250 so that sleeve 402 may be attached in a slightly curved manner. This may create a three-dimensional pre-shaped sleeve in the area of the elbow.

FIG. 5 shows the pattern corresponding to FIG. 4 of the back area 501 and the second sleeve 502 of the article of sportswear 200 from FIG. 2. Similar to FIG. 4, FIG. 5 illustrates seam 270 with lower section 271 and upper section 272, shoulder seam 230, back seam 250, sleeve seam 260 and seam 261, three-dimensional area 220 formed by heat at the elbow, collar 231, lower edge 275 and sleeve edge 285. Seams having the same reference numerals are connected to form a seam during manufacture. As for the other figures, reference numerals in both figures are only shown for one of the two symmetric sides.

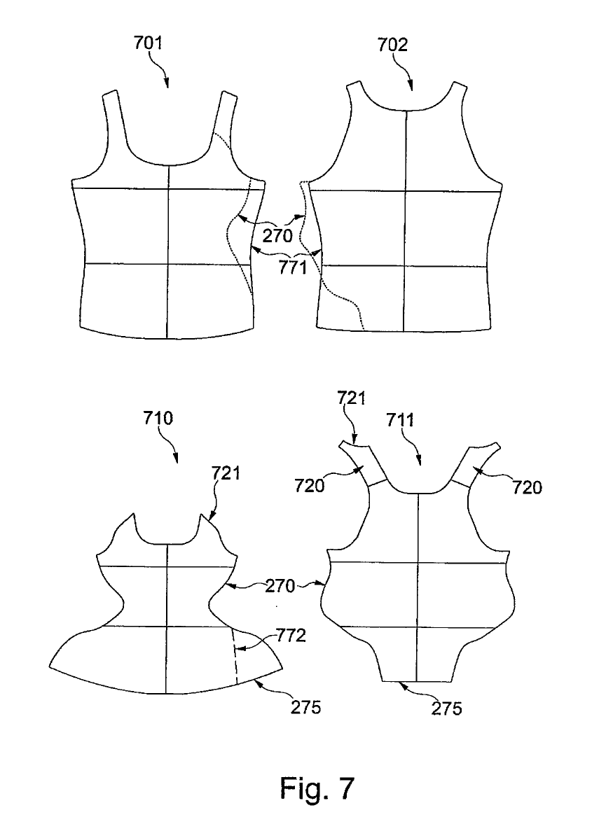

FIG. 6 shows a pattern of an article of sportswear made from a single piece of textile material 600. A front area 601 and a back area 602 can be recognized. In an alternative embodiment (not illustrated), both areas may be exchanged. Further, FIG. 6 shows head opening 690, curved lower edge 275 and seam 270 with lower section 271 and upper section 272, both respectively in front area 601 and in back area 602. By connecting sections 271, 272 from front area 601 with the corresponding sections 271, 272 from back area 602 which results in seam 270, an article of sportswear is obtained from pattern 600. As can further be recognized in FIG. 6, there is shoulder seam in pattern 600 which increases wearer comfort.

FIG. 6 further shows conventional seam 672 for connecting front area 601 and back area 602. As shown in FIG. 6, conventional seam 672 may require a cut-out 673, in order to adjust the three-dimensional shape of the article of sportswear to the shape of the body, in particular a smaller diameter in the area of the waist than in the area of the breast and the hip. However, a corresponding three-dimensional shape can be obtained by the curved shape of the inventive seam 270, without requiring the complex cut-out 673. Seam 270 therefore fulfils a further function, apart from avoiding areas which are sensitive for skin chafing. Shaping of three-dimensional areas using curved seams is described below in connection with FIGS. 12 and 13.

The upper part of FIG. 7 shows a further pattern for an article of sportswear with front area 701, back area 702, and seam 270. This figure shows particularly well how seam 270 is obtained by shifting conventional seam 771 which thereby essentially circumvents the area around conventional seam 771 which is critical for skin chafing. Nevertheless, seam 270 may be appropriate as a connecting seam between front area 701 and back area 702 since it remains in a wider area of frontal plane 32 (see FIG. 3). However, seam 270 only intersects frontal plane 32 and curves away from it while conventional seam 771 completely remains along the frontal plane 32.

The lower part of FIG. 7 also shows a pattern of an article of sportswear having a front area 710 and a back area 711. Again, shifted seam 270, conventional seam 772 and lower edge 275 are illustrated. Lower edge 275 may be curved towards front area 710. The figure further shows that shoulder areas 720 of back area 711 may be elongated such that the resulting shoulder seam 721 may no longer be located on the shoulder and therefore bypasses this sensitive area when front area 710 and back area 711 are connected. Therefore, the resulting article of sportswear may have neither the conventional shoulder seam nor the conventional side seam.

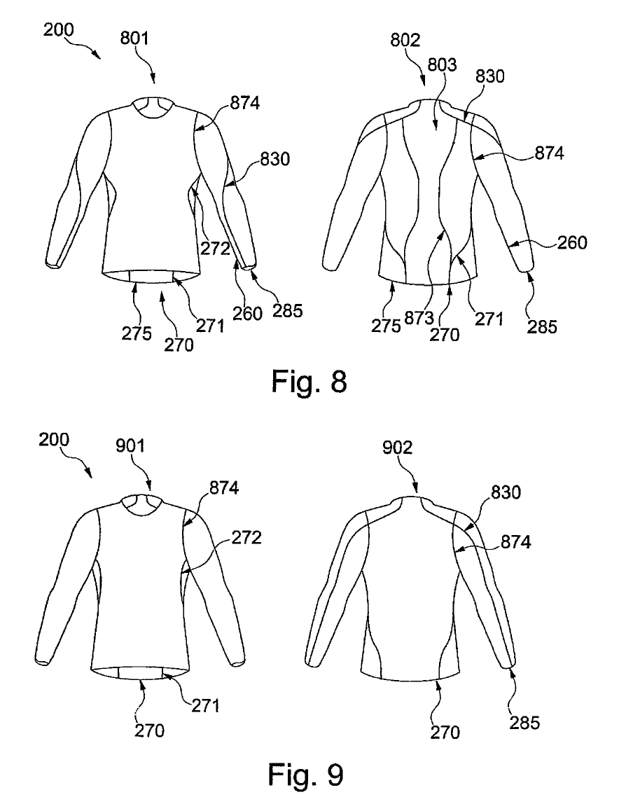

FIG. 8 shows a further embodiment of the article of sportswear 200 of FIG. 2. Again, the curved seam 270 can be recognized which extends from lower edge 275 on back side 802 to the armpit area of the article of sportswear where it meets sleeve seam 260. Lower section 271 of seam 270 may extend at least partially on back side 802, and upper section 272 of seam 270 may extend at least partially on front side 801 of the article of sportswear. Again, in some embodiments lower section 271 and upper section 272 may be oppositely curved. Further, shoulder seam 830 can be recognized which extends in the shoulder area on back side 802.

Compared to FIG. 2, a number of differences can be recognized in FIG. 8. Seam 270 splits above lower edge 275 in lower section 271 and a further seam 873 which extends to shoulder seam 830. Seam 873 may be curved and may comprise, in some embodiments, several oppositely curved sections. Seam 873 may delimit, together with shoulder seam 830 and lower edge 275, an area 803 on back side 802 wherein in one embodiment a climate insert can be arranged. In some embodiments, the climate insert may comprise a fabric permeable to air so that sweat on the skin of the wearer of the article of sportswear can easily evaporate and the back remains dry. The course of seam 873 may be determined by sweat areas, for example along the spine. Seam 873 may not be necessary when there is no climate insert present.

Another difference from the article of sportswear 200 of FIG. 2 is that shoulder seam 830 does not split in this embodiment but extends curvedly on front side 801 to sleeve edge 285. During transition from back side 802 to front side 801, shoulder seam 830 and frontal plane 32 (see FIG. 3) may intersect. Again, shoulder seam 830 may run below the shoulder and therefore may avoid a sensitive area. Further, another seam 874 may run as an extension of sleeve seam 260 over the shoulder of the article of sportswear, and may intersect with shoulder seam 830 and may meet again with sleeve seam 260 on the other side of the shoulder. In some embodiments, seam 874 may only be present when there is no three-dimensional area formed by heat on the shoulder.

In some embodiments, seam 874 may be manufactured by stitching while the other seams may be bonded by a method which is described in more detail in connection with FIG. 20.

FIG. 9 shows a further embodiment of the article of sportswear 200 from FIG. 2. Similar to FIG. 8, this embodiment may comprise seam 874 at the shoulder. Other than in FIG. 8, shoulder seam 830 may extend completely on back side 902 of the article of sportswear, and back side 902 does not comprise seam 873 of FIG. 8. Preferably, seam 874 and shoulder seam 830 may be executed as a flat lock seam. Seam 874 may not be necessary when there is a three-dimensional area formed by heat arranged on the shoulder.

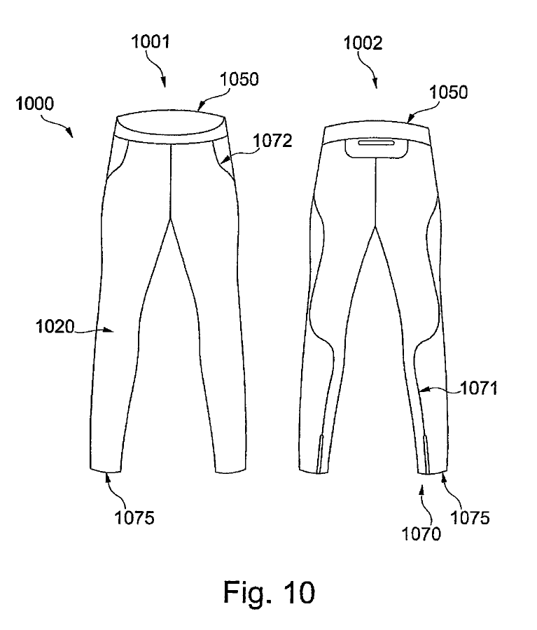

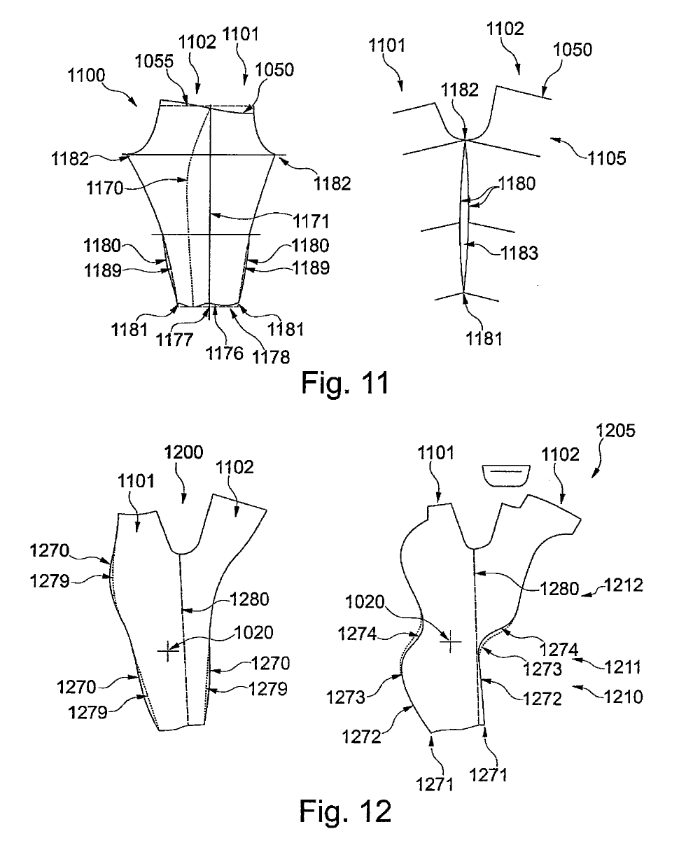

FIG. 10 is a schematic view of a further embodiment of an article of sportswear in which a front side 1001 and a back side 1002 of pants 1000, in particular tight-fitting pants, can be recognized. In order to reduce their disadvantages, the seams of the article of sportswear shown in FIG. 10 may be shifted with respect to conventional straight seams and therefore circumvent areas critical for skin chafing between the legs. In particular, there may be no seam on the inside of the legs. Rather, as can be recognized in FIG. 10, a curved seam 1070 extends from lower edge 1075 on back side 1002 of the article of sportswear 1000. In further embodiments (not illustrated), seam 1070 may comprise one or more straight sections. Further, FIG. 10 shows a trouser waistband 1050 which is explained in more detail in connection with FIG. 11.

Seam 1070 may comprise two sections wherein lower section 1071 may extend at least partially on back side 1002, and upper section 1072 may extend at least partially on front side 1001 of the article of sportswear. In a further embodiment (not illustrated), lower section 1071 may extend on front side 1001 and upper section 1072 may extend on backside 1002.

In order to improve freedom of movements for the wearer of the article of sportswear 1000, a three-dimensional area 1020 formed by heat may be arranged in the area of the knee which may reduce stretching and compressing of the article of sportswear during movements. Further, lower edge 1075 may be anatomically shaped, in particular by a recess omitting the ankle which reduces skin chafing in this area, in particular for tight-fitting sportswear. This is explained in more detail in connection with FIG. 15.

FIGS. 11 and 12 illustrate how, starting from a conventional pattern, the pattern for an article of sportswear according to the invention as in FIG. 10 can be obtained. On the left side in FIG. 11, a pattern 1100 of a trouser leg of an article of sportswear with a front area 1101 and a back area 1102 can be recognized. The figure shows conventional trouser waistband 1055 and seams 1180 running at the boundary of pattern 1100. By connecting seams 1180, conventional inner seam 1180 between the legs is generated. Further, FIG. 11 shows separating line 1171 between front area 1101 and back area 1102 which corresponds to a conventional outer seam of a pair of trousers. Separating line 1171 further corresponds to the intersection of frontal plane 32 with a body on which the article of sportswear 1000 is worn (see FIG. 3).

Pattern 1100 in FIG. 11 shows how seams according to the invention are formed from a conventional pattern. In particular, conventional trouser waistband 1055 may be moved downwards in front area 1101, preferably by 3-4 cm, and may be raised in back area 1102, preferably by 2-3 cm, which generates the shifted trouser waistband 1050 which is also illustrated in pattern 1105 on the right side of FIG. 11. This leads to a trouser waistband which follows the anatomical contour of the pelvic girdle and corresponds to its shape.

Further, conventional separating line 1171 between front area 1101 and back area 1102 is curved and shifted to back area 1102 in order to obtain line 1170, as can be seen in FIG. 11. In some embodiments, seam 1180 is shifted with respect to conventional seam 1189 by 1-2 cm, in order to obtain an anatomical shape.

FIG. 11 further shows trouser leg edge 1176 which may be curved compared to conventional straight trouser leg edge 1178, in order to avoid skin chafing. In particular, trouser leg edge 1176 is curved so that there may be a recess 1177 for the ankle which may reduce chafing and pressure in this area. The recess 1177 for the ankle may be located in the area of the intersection between trouser leg edge 1176 with separating line 1171 and therefore also with frontal plane 32 (see FIG. 3).

In order to obtain a pattern without an inner seam 1180, pattern 1100 may be cut open along the new line 1170 and connected at points 1181 and 1182, as shown in pattern 1105 on the right side of FIG. 11. This generates a cut-out 1183 between points 1181 and 1182 since edges 1180 do not run in parallel.

By joining along edges 1180, cut-out 1183 can be avoided. This results in the left pattern 1200 in FIG. 12 in which the adapted edges 1180 from FIG. 11 are designated as line 1280 which corresponds to original inner seam 1180 of conventional pattern 1100 from FIG. 11 which can be advantageously be dispensed with in pattern 1200.

FIG. 12 further shows edges 1279 obtained by separating the shifted line 1170 in pattern 1100 of FIG. 11 and which therefore essentially run in parallel. By shifting them and adding 1-2 cm, edges 1270 may be created which provide an anatomical shape. By further shifting edges 1270 in a way so that both edges 1270 of pattern 1200 do not run in parallel, edges 1271 in pattern 1205 on the right side of FIG. 12 are generated. By connecting the non-parallel edges 1271 to a seam, a three-dimensionally curved surface may be generated which enables an adjustment to anatomical shapes. This will explained in the following in more detail. Connection of edges 1271 generates in particular a seam which corresponds to seam 1070 of the article of sportswear 1000 in FIG. 10.

The three-dimensionally curved shape of sports pants generated by connecting edges 1271 can be described as follows. Starting from the lower edge of the sports pants, the diameter of the leg of the sports pants may initially increase since the distance of the respectively sewed points 1272, 1273 may increase in the area of the calf 1210. In the area of the knee 1211, the diameter of the leg of the sports pants may essentially remain constant since the distance of the respectively sewed points 1273, 1274 may essentially remain constant in the area of the knee 1211. Finally, the diameter of the sports pants may increase since the distance of the respectively sewed points in the area of the thigh 1212 may increase. This progression of the curvature corresponds to the progression of the curvature of the article of sportswear 1000 in FIG. 10. The resulting shape is an example of a three-dimensional shaped area which is created by a correspondingly shaped curved seam to form a three-dimensional garment.

FIG. 12 further shows crosses for positioning of a mold for creating a three-dimensional area formed by heat at the knee. This will be explained in more detail in connection with FIG. 19 below.

In some embodiments and as shown in several preceding examples, the edges and seams may be smoothly curved so that they do no comprise kinks. A particular advantage of smoothly curved edges and seams may be that the resulting three-dimensional surfaces are also smoothly curved and have no kinks. Such kinks may arise, for example, when the seams of the pattern for forming the three-dimensional shape consist of section of straight lines.

The use of oppositely curved seams, as also illustrated in several examples, has a further advantage that three-dimensional shapes with changing curvatures, for example decreasing and increasing diameters as described above, can be formed which nevertheless are smoothly curved and have no kinks in their curvature. This feature may be particularly important for tight-fitting articles of sportswear since it may increase freedom of movement and wearer comfort and may reduce skin chafing. This provides another example of a three-dimensionally shaped area which is created by a correspondingly shaped curved seam to form a three-dimensional garment.

FIG. 13 shows patterns for an article of sportswear, in particular tennis shorts, which illustrate a further example of creating three-dimensionally shaped articles of sportswear. In FIG. 13, pattern 1301 for tennis shorts 1300 can be recognized. Pattern 1301 includes a pair of edges 1370 which may be connected to obtain a corresponding seam 1370 of tennis shorts 1300. Edges 1370 comprise a plurality of oppositely curved sections. In particular, edges 1370 may not run in parallel. As a result of the shape of edges 1370, their connection may lead to a three-dimensional shape which from bottom to top initially gets wider, as long as the (flat) edges 1370 of pattern 1301 approximate each other. Towards the lower edge of pattern 1301, edges 1370 may depart from each other so that the three-dimensional shape in this area becomes tighter when connecting edges 1370. This illustrates forming of three-dimensional surfaces having a changing curvature by connecting non-parallel edges having a changing curvature. This provides another example of a three-dimensional shaped area which is created by a correspondingly shaped curved seam. In contrast to edges 1370, edges 1380 of pattern 1301 run in parallel so that no three-dimensional form is created when connecting edges 1380.

FIG. 14 is a schematic view of a further embodiment of an article of sportswear. In the figure, a front side 1401 and a back side 1402 of shorts can be recognized. A curved seam 1470 may extend from lower edge 1475 on back side 1402 of the article of sportswear. Preferably, seam 1470 may essentially comprise two sections, wherein lower section 1471 may extend at least partially on back side 1402 and wherein upper section 1472 may extend at least partially on front side 1401 of the article of sportswear. In some embodiments, lower section 1471 and upper section 1472 may be oppositely curved. In a further embodiment (not illustrated), lower section 1471 may extend on front side 1401 and upper section 1472 may extend on back side 1402. Seam 1470 may comprise one or more straight sections.

FIG. 15 shows embodiments of an article of sportswear in the area of the trouser leg edge and the sleeve edge. The two left figures show a front view 1501 and a side view 1502 of an article of sportswear such as shown in FIG. 10. In the figure, trouser leg edge 1575 may be curved to avoid skin chafing. In particular, trouser leg edge 1575 may be curved so that a recess 1578 is formed in the area of ankles 1577 to avoid chafing and pressure on ankles 1577.

In one embodiment which simplifies manufacture, trouser leg edge 1576 has a simplified shape. In front view 1501, the curvature of trouser leg edge 1576 may be essentially constant, while the curvature of trouser leg edge 1576 in side view 1502 may change in the area of ankle 1577 so that it omits ankle 1577. This simplified form of trouser leg edge 1576 may still provide adequate functionality and a simplified manufacture of the article of sportswear.

In a similar way, the illustration on the right of FIG. 15 shows a view of a sleeve 1503 of an article of sportswear such as shown in FIG. 2. In the figure, a sleeve edge 1585 can be recognized which is curved so that it forms a recess 1588 for the bones of the wrist 1587 and therefore may avoid chafing and pressure on the bones of the wrist 1587. Recess 1588 for wrist 1587 can be seen, for example, in the curved sleeve edges 285 in FIG. 2.

FIG. 16 shows a view of a person wearing an article of sportswear in the area of the collar and the shoulder. In back view 1601, cervical vertebra 1677 with the seventh cervical vertebra 1678, thoracic vertebra 1680 with the first thoracic vertebra 1681, and the upper trapezius muscles 1685 can be recognized. In back view 1602, an area 1690 is marked whose lower edge 1691 essentially contours the seventh cervical vertebra 1678 and the upper trapezius muscles 1685 and therefore circumvents these areas. A corresponding form of a seam therefore leads to an article of sportswear which avoids skin chafing in these sensitive areas.

A corresponding article of sportswear is illustrated in back view 1604 of FIG. 16 in which an upper area 1694 and a collar 1693 of an article of sportswear may be connected along lower edge 1691. Collar 1693 may be further delimited by upper edge 1692 which may be essentially uniformly curved in back view 1604.

In front view 1603, the further run of lower edge 1691 can be recognized where it may be essentially uniformly curved. In contrast to this, upper edge 1692 may curve towards lower edge 1691 and may form angle 1695, preferably an acute angle, in the middle of the neck. This run of upper edge 1692 may essentially contour the clavicle bone in this area.

Lower edge 1691 of collar 1692 may run along the seventh cervical vertebra, the trapezius muscles, and the clavicle bone. The seventh cervical vertebra and the trapezius muscles may be bypassed in this way, in order to avoid pressure in these sensitive areas by upper edge 1692, which forms a fixing point for the form of collar 1693 in the area of the back and the neckline.

In some embodiments, collar 1693 may be differently padded in different areas, in order to protect the upper trapezius muscles 1685. The padding may be provided in another embodiment by a pre-shaped member or molded member such as a foam member. In a further embodiment (not illustrated), collar 1693 may comprise a three-dimensional area formed by heat. In some embodiments, collar 1693 may comprise no seams.

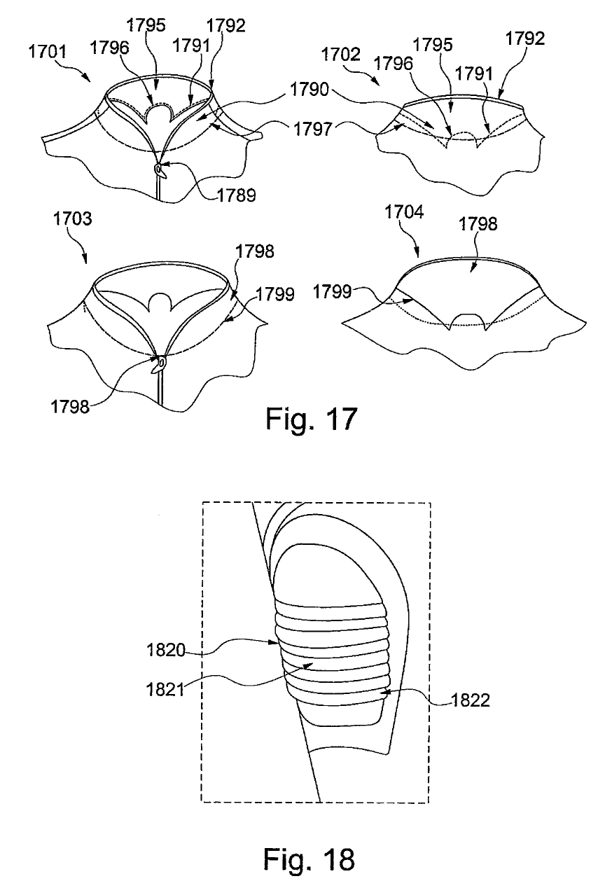

FIG. 17 shows further embodiments of an article of sportswear in the area of the collar. The first embodiment of a collar 1790 may be illustrated in front view 1701 and in back view 1702, which in contrast to the embodiment of FIG. 16 does not comprise a circumferential lower edge. Rather, on the back side of collar 1790 a padded area 1795 may be arranged whose upper edge may be flush with upper edge 1792. Upper edge 1792 has a shape similar to upper edge 1692 of FIG. 16 so that it forms an angle 1789, preferably an acute angle 1789, in the middle of the neck in front view 1701 and therefore may contour the clavicle bone.

Lower edge 1791 of padded area 1795 may comprise several curved sections and is again similar to the shape of lower edge 1691 of FIG. 16. In particular, lower edge 1791 may comprise section 1796 which may contour seventh cervical vertebra 1678 and/or first thoracic vertebra 1681 from view 1601 of FIG. 16, in order to avoid an irritation of these vertebras by the article of sportswear. This is also illustrated by line 1797 which indicates the conventional form of the upper edge of a collar. Line 1797 may intersect both with an area of the first cervical vertebra 1678 and/or the first thoracic vertebra 1681 as well as an area of the upper trapezius muscles 1685. The irritation of these areas caused by conventional collar edge 1797 may be advantageously avoided by the particular form of lower edge 1791 which omits these areas.

A second embodiment of collar 1970 is illustrated in front view 1703 and back view 1704 of FIG. 17 which, in contrast to the embodiment of views 1701 and 1702, may comprise a circumferential collar 1798 which has a circumferential lower edge 1799. As can be recognized, angle 1789 may touch lower edge 1799.

FIG. 18 is a view of an embodiment of a stretchable area of an article of sportswear which may be arranged in the area of joints such as the elbow which require high freedom of movement. As can be recognized, a stretchable area 1820 in FIG. 18 may be formed by a bellow insert 1821. Insert 1821 may be manufactured from a textile material which differs from the material of the article of sportswear and which may in particular comprise elastic material. Insert 1821 may comprise plural folds of the textile material which unfold when the underlying joint bends. This may increase freedom of movements and wearer comfort of the article of sportswear since unfolding requires less force than stretching a tight-fitting elastic material. During frequent movements this may have a considerable positive effect on the fatigue of a wearer of the article of sportswear.

FIG. 19 is a view of an apparatus for molding of textile materials for three-dimensional areas formed by heat of an article of sportswear. As can be recognized, FIG. 19 shows two views of a molding machine 1901 with a mold 1920, a plate 1940, and an opening 1921. Mold 1920 corresponds to the desired shape of the body, for example a shoulder or an elbow. In alternative embodiments, the three-dimensional areas may not be formed by heat, but by other methods such as application of pressure.

During molding, the textile material may be first positioned over opening 1921. Then, plate 1940 may be lowered which fixes the textile material 1930 on opening 1921. The heated mold 1920 may be subsequently pressed through opening 1921 so that the textile material 1930 is stretched. The textile material 1930 may be rapidly deformed by this stretching under the impact of the heated mold 1920. After a certain time period, the textile material may be released again. As a result, it may be permanently deformed. The three-dimensional forming of the textile material can also be achieved by other means such as the use of a negative mold.

Table 1 shows exemplary molding parameters. As can be seen, the article of sportswear may be essentially made from polyester (PES), and in some embodiments may be made from 100% polyester. The three-dimensional area formed by heat may be manufactured by molding at a temperature in a range between 150° C.-200° C., and in some embodiments the temperature may be in a range between 185° C.-195° C. This combination of material and temperature provides a particularly effective forming of the three-dimensional area.

In an alternative embodiment, the article of sportswear may be essentially made from a nylon-elastan-blended fabric, and in some embodiments may be made from 100% Nylon-Elastan-blended fabric. In this case, the three-dimensional area may be formed at a temperature in a range between 150° C.-200° C., and in some embodiments the temperature may be 195° C.

In some embodiments, molding of the article of sportswear lasts 10-25 seconds. Already after this time a permanent shaping of the three-dimensional area is obtained, without, on the other hand, damaging the material of the article of sportswear. Mold 1920 may have an immersion depth of 1.5-2.5 times the depth of the article of sportswear obtained by molding. The immersion depth of mold 1920 in some embodiments may be in the range of 45 mm to 90 mm, and the resulting depth of the article of sportswear may be in the range of 15 mm to 60 mm.

TABLE 1
Molding Parameters

| | | | | Molding | Molding | Mold | |
|---|---|---|---|---|---|---|---|
| Fabric | | | | Temperature | period | depth | Result |
| Name | Type | Composition | Mold | C. | s | mm | mm |
| Toray | Knit | 100% PES | Breast diameter | 190 | 10 | 50 | 22 |
| | | | 120 mm | | | | |
| | | | Shoulder Size | 195 | 25 | 81 | 37 |
| | | | 90 mm | | | | |
| | | | Shoulder Size | 195 | 25 | 60 | 35 |
| | | | 76 mm | | | | |
| | | | Shoulder Size | 195 | 25 | 50 | 27 |
| | | | 76 mm | | | | |
| Toray | Woven | 100% PES | Shoulder Size | 195 | 25 | 84 | 31 |
| FX2702 | | | 90 mm | | | | |
| | | | Shoulder Size | 195 | 25 | 70 | 22 |
| | | | 76 mm | | | | |
| | | | Breast diameter | 190 | 10 | 50 | 20 |
| | | | 120 mm | | | | |
| Edat | Knit | 95% | Breast diameter | 195 | 25 | 55 | 30 |
| | | Nylon, | 120 mm | | | | |
| | | 5% Elastan | | | | | |

FIG. 20 is an illustration of a method for seam manufacturing in which the following steps can be recognized. In the first step 2001, the two edges of the textile material to be connected may be placed upon each other. In the second step 2002, the two edges may be welded together, and the overlap may be cut off. In the third step, the bonded textile material may be opened so that welded seam 2020 gets visible. In the fourth step 2004, welded seam 2020 may be covered by a bonding tape 2021. This results in the fifth step 2005 in a very smooth seam 2021 on the side of the textile material opposite to the bonding tape 2021 which may significantly reduce skin chafing. Alternatively to the method described above, the edges can be glued or welded using a method known in the prior art, and the generated seam may subsequently be covered by a bonding tape.

According to a second aspect of the invention which can be applied independently of the previously described embodiments, a garment comprises three-dimensionally shaped areas generated by connecting two edges of a pattern, wherein each of the two edges comprises several oppositely curved sections, and wherein the two edges of the pattern do not run in parallel. This leads to three-dimensionally shaped areas with oppositely curved surfaces for high freedom of movements and wearer comfort. Preferably, the edges of the pattern may be smoothly curved which leads to smoothly curved three-dimensional surfaces, as described above. In one embodiment of this aspect of the invention, the garment may further comprise three-dimensional areas formed by heat.

What is claimed is:

1. A garment comprising:
a three-dimensional heat molded area; and
a seam connecting a front area of the garment with a back area of the garment, wherein the seam is curved and shaped to create a three-dimensionally shaped area.

2. The garment of claim 1, wherein the seam intersects a medial frontal plane of a body of a wearer of the garment.

3. The garment of claim 2, wherein the curved seam intersects the medial frontal plane of the body of the wearer more than once.

4. The garment of claim 1, wherein the seam comprises oppositely curved sections.

5. The garment of claim 1, wherein the seam comprises an upper curved section which extends in front of a medial frontal plane of the garment and a lower curved section which extends behind the medial frontal plane of the garment.

6. The garment of claim 1, wherein the front area and the back area are manufactured from a single textile part.

7. The garment of claim 1, wherein the seam is a bonded structure.

8. The garment of claim 1, wherein the seam is located on a side of the garment opposite to the skin of a wearer.

9. The garment of claim 1, further comprising a sleeve, wherein an edge of the sleeve is formed so that it comprises a recess for bones of a wearer's wrist.

10. The garment of claim 1, further comprising a leg, wherein an edge of the leg is formed so that it comprises a recess for bones of a wearer's ankle.

11. The garment of claim 1, further comprising a stretchable insert.

12. The garment of claim 1, further comprising a bellow insert.

13. The garment of claim 1, wherein the three-dimensional heat molded area is located in an area corresponding to a wearer's body part selected from the group consisting of a neck, a shoulder, an elbow, a breast, a knee, and a waist.

14. A garment comprising:
a three-dimensional heat molded area; and
a curved seam connecting a front area of the garment with a back area of the garment to create a three-dimensionally shaped area, wherein:
the curved seam intersects a medial frontal plane of a body of a wearer more than once; and
the curved seam comprises an upper curved section which extends in front of the medial frontal plane and a lower curved section which extends behind the medial frontal plane.

15. The garment of claim 14, further comprising a sleeve, wherein an edge of the sleeve is formed so that it comprises a recess for bones of a wearer's wrist.

16. The garment of claim 14, further comprising a leg, wherein an edge of the leg is formed so that it comprises a recess for bones of a wearer's ankle.

17. The garment of claim 14, further comprising a stretchable insert.

18. The garment of claim 14, further comprising a bellow insert.

19. A garment comprising:
a three-dimensional heat molded area; and
a curved seam connecting a front area of the garment with a back area of the garment to create a three-dimensionally shaped area,
wherein the curved seam intersects a medial frontal plane of a body of a wearer of the garment and the curved seam comprises oppositely curved sections.

20. A method of making a garment comprising the steps of:
providing a textile material;
molding a portion of the textile material with heat to form a three-dimensional molded area; and
forming a curved seam with an edge of the textile material to create the three-dimensionally shaped area,
wherein the curved seam intersects a medial frontal plane of a body of a wearer of the garment and the curved seam comprises oppositely curved sections.

21. The method of claim 20, wherein the garment comprises polyester and the three-dimensional molded area is molded at a temperature in a range from about 150° C. to about 250° C.

22. The method of claim 20, wherein the garment comprises polyester and the three-dimensional molded area is molded at a temperature in a range from about 185° C. to about 195° C.

23. The method of claim 20, wherein the garment comprises a blended fabric of nylon and elastan and the three-dimensional molded area is molded at a temperature in a range from about 150° C. to about 250° C.

24. The method of claim 20, wherein the garment comprises a blended fabric of nylon and elastan and the three-dimensional molded area is molded at a temperature in a range from about 185° C. to about 195° C.

25. The method of claim 20, wherein the molding step has a duration in a range from about 10 seconds to about 25 seconds.

26. The method of claim 20, wherein the molding step comprises using a mold with an immersion depth having about 1.5 to about 2.5 times a resulting depth of the garment.

27. The method of claim 20, wherein the molding step comprises using a mold having an immersion depth in a range from about 45 mm to about 90 mm and wherein a resulting depth of the three-dimensional molded area is in a range from about 15 mm to about 60 mM.
